(19) United States
(12) Patent Application Publication
(10) Pub. No.: US 2011/0000609 A1
(43) Pub. Date: Jan. 6, 2011

(54) Removable and customizable traction decks for miniature skateboards and method of making

(76) Inventor: Corey Michael Carrillo, Solana Beach, CA (US)

Correspondence Address: ERIC HANSCOM, 2141 Palomar Airport Road, Suite 320, CARLSBAD, CA, 92011, US

(21) Appl. No.: 12/495,820

(22) Filed: Jul. 1, 2009

(51) Int. Cl. B29C 65/48

(52) U.S. Cl. 156/249

(57) ABSTRACT

This invention relates to the general field of fingerboards, or miniature skateboards, and more specifically, to a textured deck application for miniature skateboards. The textured deck is created by cutting a piece of grip tape into a shape approximating the surface of a fingerboard. Mirror image textured decks are created by taking two textured decks of different colors, cutting both with the same pattern, then switching elements from one deck with the matching elements of the other deck.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of fingerboards, or miniature skateboards, and more specifically, to a textured deck application for miniature skateboards. The textured deck is created by cutting a piece of grip tape into a shape approximating the surface of a fingerboard. Mirror image textured decks are created by taking two textured decks of different colors, cutting both with the same pattern, then switching elements from one deck with the matching elements of the other deck.

The miniature skateboard, or fingerboard, has become one of the most popular toys of the last decade or two. Less than 4 inches long, the miniature skateboard is a portable toy that teaches hand-eye coordination in a manner that many parents find preferable to the same benefits claimed by some video game machines. The fingerboard is controlled generally with two fingers of the same hand, and simulates a real skateboard, with the two fingers serving the same function as the two feet of a rider on a real skateboard.

A major problem in the miniature skateboard market is the fact that finger skateboards are made of plastic and other slick materials, and are used by children in the pre-teen and teenage years, many of whom have dirty, oily or greasy fingers through a combination of skin oil, the eating of greasy food, and a general revulsion at the idea of washing hands.

Thus there has existed a long-felt need for a means by which a fingerboard can be fitted with a means by which a user's fingers will not slide off the board during use. The invention of the textured deck application was made to provide a product that allowed users—even those with dirty fingers—to successfully grip the fingerboard as they rode it. To further enhance the desirability of the textured decks, it is possible to create a customized deck by cutting different patterns from more than one color of grip tape, then matching them up in creating one miniature textured deck. A preferred embodiment of the invention provides mirror image textured decks, where the same pattern is used to cut two different colors of grip tape, and after one or more parts of the pattern is exchanged with the same part of the other color, two mirror image textured decks are used. This is particularly effective where one user can “ride” two fingerboards simultaneously with both hands, or when two users ride mirror image fingerboards in synchronized fingerboard performances.

### SUMMARY OF THE INVENTION

It is a principal object of the invention to provide a textured deck for a miniature skateboard.

It is another object of the invention to provide a method of making a customizable textured deck for a miniature skateboard.

A further object of the invention is to provide a method of making two or more mirror image textured decks for miniature skateboards.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is series of side views of the textured deck applications with different means of attachment by which the user can control the fingerboard upon which the textured deck application material is applied.

FIG. 2 is a top view showing the preparation of a single-color textured deck.

FIG. 3 is a top view showing the preparation of two two-color textured decks that are identical to each other.

FIG. 4 is a top view showing the preparation of two two-color textured decks that are mirror images of each other.

FIG. 5 is a top view showing the preparation of three three-color textured decks.

### DETAILED DESCRIPTION OF THE FIGURES

Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

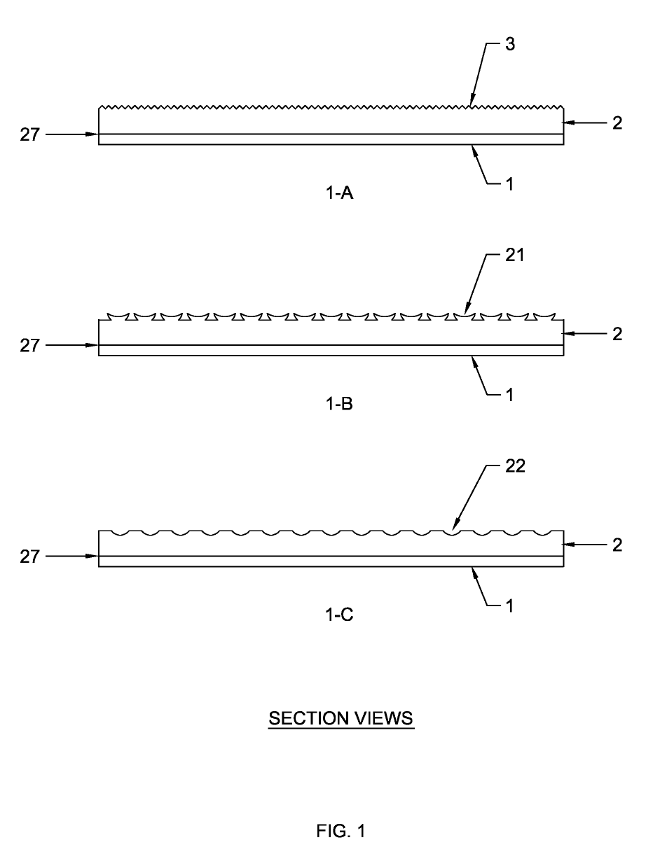

FIG. 1 is series of side views of the textured deck applications with different means of attachment by which the user can control the fingerboard upon which the textured deck application material is applied. FIG. 1A shows a piece of textured deck application with a backer layer (1), and a grip layer (2), with a sticky side (27) which, when removed from the backer layer, will adhere to the deck of a miniature skateboard, and where the grip layer has means of attachment (3), which in this case is a rough external surface. FIG. 1B shows a piece of textured deck application material where the means of attachment (21) is a series of miniature suction cups which are designed to grip onto the user's finger to facilitate control of the fingerboard. FIG. 1C illustrates a piece of textured deck application material where the means of attachment are a series of indentations (22) in the external surface of the grip layer, where a user's finger will force the air out of the indentations and suction will then adhere the user's finger to the textured deck.

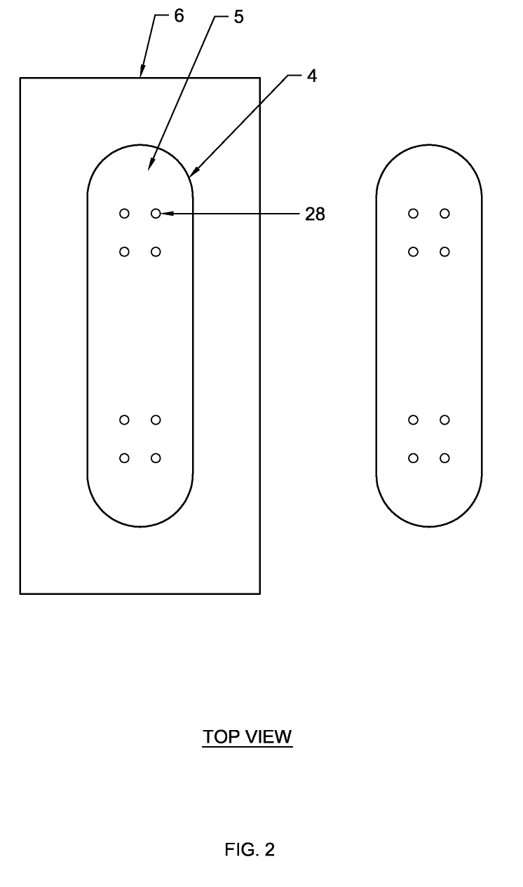

FIG. 2 is a top view showing the preparation of a single-color textured deck. A single color of material is taken, and a tracing (4) of the deck of a miniature skateboard is applied to the surface of the material. The material is then cut, by means of scissors, knives, die cutting or any other known method of cutting, into the desired shape (5). The excess (6) is pulled off the backer layer (1), such that the desired shape (5) can be removed and attached to a miniature skateboard. So that the textured deck can be applied smoothly over the deck of the miniature skateboard, eight holes (28) are cut into the textured deck to fit over screw heads found on most miniature skateboards.

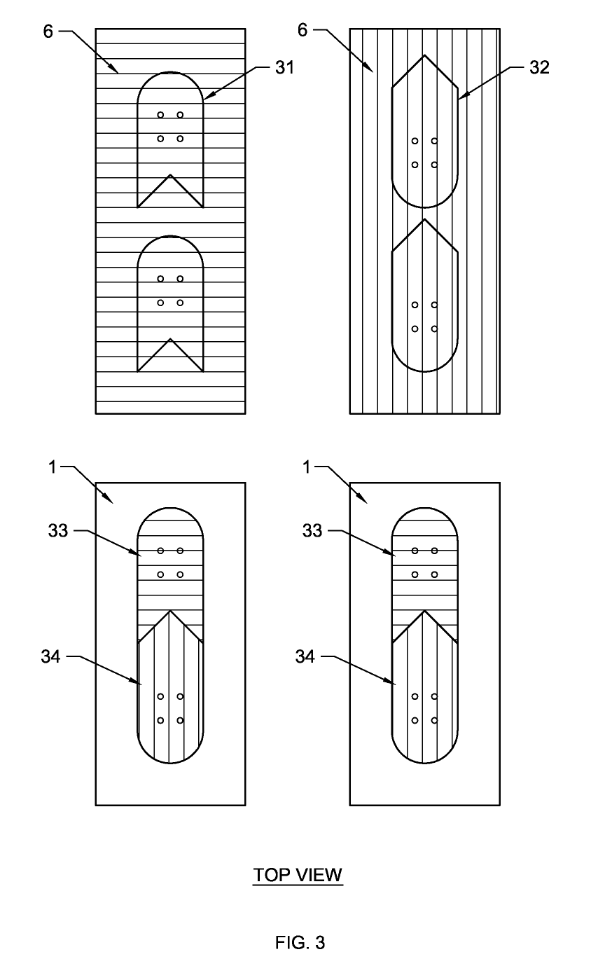

FIG. 3 is a top view showing the preparation of two two-color textured decks that are identical to each other. Identical patterns (31) are cut into one color of material, which mating patterns (32) are cut into a second color of material. Once the excess (6) is removed, the desired shapes (33 and 34) can be removed and reassembled into a complete textured deck and stored on the backer layer (1) until they are attached to the miniature skateboard. It should be noted that for FIGS. 3-5, the stripes and lines on the figures represent different colors and are not meant to signify any contour lines.

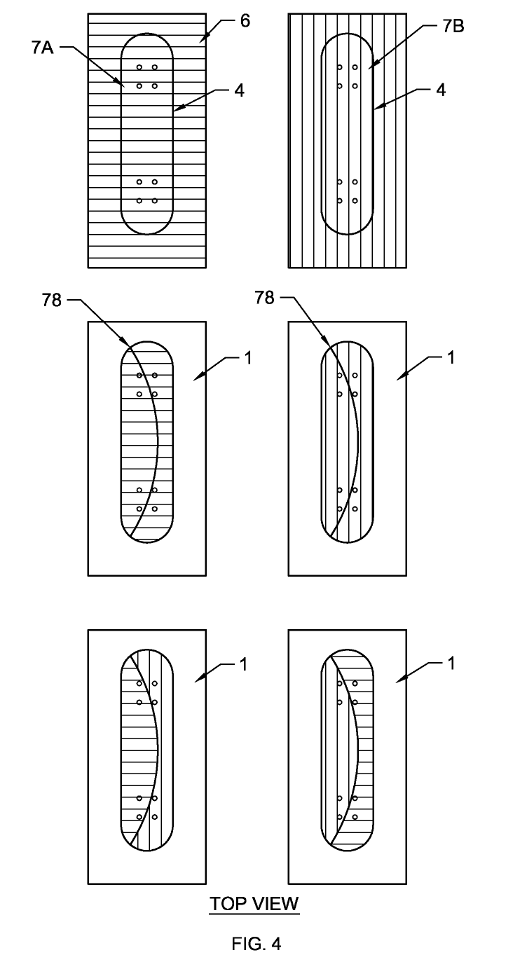

FIG. 4 is a top view showing the preparation of two two-color textured decks that are mirror images of each other. Two identical patterns (7A and 7B) are cut into two different colors of material and the excess (6) removed. The same pattern (78) is then cut into both desired shapes. The same part of the two colors is then swapped, created mirror image textured decks.

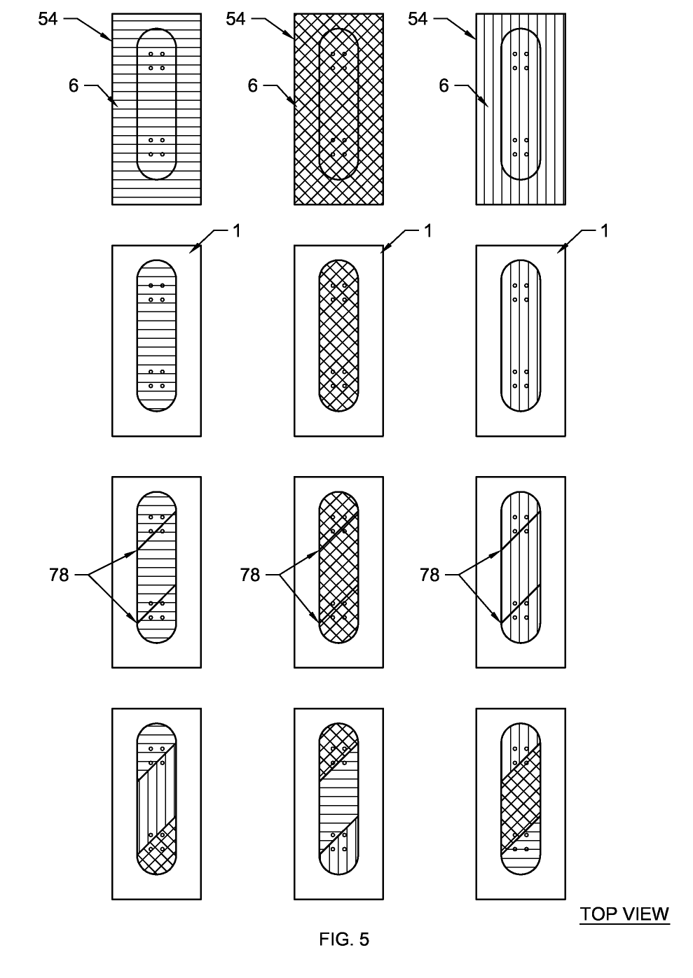

FIG. 5 is a top view showing the preparation of three three-color textured decks. An identical tracing (54) is cut into three colors of material and the excess (6) removed. An identical pattern (78) is then cut into all three colors of material, where the identical pattern comprises at least two cuts, rendering at least three pieces of the same color of material. These pieces are then swapped between the other pieces to create three textured decks with similar colors in different arrangements.

What I claim is:

1. A method of making a textured deck for a miniature skateboard, comprising, first, obtaining a piece of textured deck application material, where the textured deck application material comprises a backer layer and a grip layer, where the grip layer consists of a sticky side, a body portion, and a grip side, where the grip side has means of attachment by which a miniature skateboard can be controlled by a user's finger, and where the backer layer is contiguous with the sticky side of the grip layer, and where the backer layer can be easily removed and reapplied to the sticky layer, second, cutting the textured deck application material to a desired shape, third, removing the grip layer of the desired shape of the textured deck application material from the backer layer, and fourth, applying the grip layer to a miniature skateboard.

2. The method of claim 1, additionally comprising a fifth step, where the fifth step comprises, removing the grip layer from the miniature skateboard and replacing it with another grip layer.

3. The method of claim 2, where the textured deck additionally comprises eight holes, where the eight holes are located such that the textured deck, when aligned on the top of a miniature skateboard will lay flat upon the deck of the miniature skateboard and the eight holes will align with eight screw tops of the miniature skateboard.

4. The method of claim 3, where the first step additionally comprises obtaining one or more additional pieces of textured deck application material, where the textured deck application material comprises a backer layer and a grip layer, where the grip layer consists of a sticky side, a body portion, and a grip side, and where the backer layer is contiguous with the sticky side of the grip layer, and where the backer layer can be easily removed and reapplied to the sticky layer, such that there are two or more pieces of textured deck application material, and the second step additionally comprises cutting the two or more pieces of the textured deck application material to one or more desired shapes, and the third step additionally comprises removing the grip layer of the desired shapes of the textured deck application material from the backer layers, and the fourth step additionally comprises taking at least one of the one or more desired shapes from the two or more pieces of textured deck application material, and applying the grip layers to a miniature skateboard.

5. The method of claim 3, where the means of attachment on the grip side is a rough surface.

6. The method of claim 3, where the means of attachment on the grip side is one or more miniature suction cups.

7. The method of claim 3, where the means of attachment on the grip side is one or more indentations into the surface of the grip side.

8. A method of making a textured deck for a miniature skateboard, comprising, first, obtaining three or more pieces of textured deck application material, where the textured deck application material comprises a backer layer and a grip layer, where the grip layer consists of a sticky side, a body portion, and a grip side, where the grip side has means of attachment by which a miniature skateboard can be controlled by a user's finger, and where the backer layer is contiguous with the sticky side of the grip layer, and where the backer layer can be easily removed and reapplied to the sticky layer, second, cutting the three or more pieces of textured deck application material to a desired shape, where the desired shape is identical for all of the three or more pieces of textured deck application material, third, removing an excess portion of the three or more pieces of textured deck application material, where the excess portion is that portion of the textured deck application material outside of the desired shape, fourth, cutting each of the three or more pieces of textured deck application material to a desired pattern, where the desired pattern is identical for all of the three or more pieces of textured deck application material, and the pattern results in at least three parts from each of the three or more pieces of textured deck application material, fifth, creating a rearrangement of each of the desired shapes by removing at least one part from each of the three or more pieces of textured deck application material, and fitting the at least one parts into the desired shape for each of the three or more pieces of textured deck application material, sixth, removing the grip layer of the desired shape of each of the textured deck application materials from the backer layers, and fourth, applying the grip layers to miniature skateboards.

9. The method of claim 8, where the textured deck additionally comprises eight holes, where the eight holes are located such that the textured deck, when aligned on the top of a miniature skateboard will lay flat upon the deck of the miniature skateboard and the eight holes will align with eight screw tops of the miniature skateboard.

10. The method of claim 9, where the means of attachment on the grip side is a rough surface.

11. The method of claim 9, where the means of attachment on the grip side is one or more miniature suction cups.

12. The method of claim 9, where the means of attachment on the grip side is one or more indentations into the surface of the grip side.
